(19) United States
(12) Patent Application Publication
(10) Pub. No.: US 2002/0140566 A1
(43) Pub. Date: Oct. 3, 2002

(54) Monitoring the condition or mechanical health of machinery.

(76) Inventor: Trevor James Holroyd, Matlock (GB)

Correspondence Address: Trexler, Bushnell, Giangiorgi,, Blackstone & Marr, Ltd., 36th Floor, 105 W. Adams, Chicago, IL, 60603, US

(21) Appl. No.: 10/100,542

(22) Filed: Mar. 18, 2002

(30) Foreign Application Priority Data
Apr. 2, 2001 (GB) 0108185.0

(51) Int. Cl. G08B 21/00

(52) U.S. Cl. 340/679; 340/680; 340/682; 340/683

(57) ABSTRACT

A method and apparatus of monitoring the condition or mechanical health of slowly rotating machinery comprises processing signals from sensing means applied to the machinery, which processing approximately or exactly sub-divides the period of a rotational cycle into a number of time or cyclic phase windows, each of which is long compared to the typical duration of a transient excitation of the structure at the frequency or frequencies of detection, applies a threshold level or acceptance criteria or calculates one in such a way that the presence or absence of any significant detectable activity in each of the time or phase windows can be determined for each rotational cycle and the fraction or percentage of those time or phase windows in which activity is present can be measured or averaged so as to provide a statistically significant indication of the extent of the activity throughout the rotational cycle.

### FIELD OF THE INVENTION

The present invention relates to a method and an apparatus for monitoring the condition or mechanical health of slowly rotating machinery and is particularly of interest for processing information contained in signals from sensors or transducers sensitive to acoustic emissions or stress waves, ultrasonic activity, noise signals and mechanical vibrations which are responsive to changes in the mechanical state or condition of slowly rotating machinery.

Acoustic emission or stress wave activity is structure borne elastic waves associated with operating machinery and is produced as a result of friction, impacts, cavitation, metal removal, crack growth, plastic deformation and other energy loss processes taking place during the operation of the machinery.

Noise signals are airborne sound waves associated with operating machinery and are produced as a result of out of balance forces, friction, impacts, cavitation, metal removal, crack growth, plastic deformation and other energy loss processes taking place during the operation of the machinery.

Ultrasonic activity is similar to noise but specifically refers to that part of the activity occurring at frequencies above the audible range (say above 20 kHz). Sometimes the term ultrasonics is used to denote the detection of structure borne activity at ultrasonic frequencies in which case it is interchangeable with the terms acoustic emission and stress wave.

Mechanical vibrations within materials and structures are associated with operating machinery and are produced as a result of out of balance forces, friction, impacts, cavitation, metal removal, crack growth, plastic deformation and other energy loss processes taking place during the operation of the machinery.

Acoustic emission, noise, ultrasonic and vibration techniques have been used to monitor the condition of machinery by assisting in the detection and diagnosis of fault conditions sometimes at an early stage. The early detection of machinery faults enables maintenance to be better planned and degrading machinery to be serviced, repaired or replaced with a minimum of disruption and cost.

A further consideration in monitoring rotating machinery is its rotational speed. As rotational speed reduces the energy release rate from fault related processes reduces as the time interval between a defect repeatedly coming into play increases. It is widely accepted that slowly rotating machinery becomes progressively more difficult to monitor at rotational speeds below 200 rpm with speeds below 60 rpm being very difficult in practice, although not necessarily impossible.

In prior art methods of processing signals responsive to the mechanical condition of slowly rotating machinery the signals derived from one or more appropriate microphones, accelerometers, transducers or other sensors are conditioned and processed in a wide variety of ways. The raw, conditioned or processed signals can be further processed in either the frequency or time domains.

In the frequency domain it is not untypical to ascribe certain frequencies or frequency bands as being related to fault mechanisms. For example it is not unusual to relate specific detected frequencies in the frequency spectrum of either the amplified vibration signal or the enveloped vibration or acoustic emission (AE) signal to pre-calculated defect repetition frequencies such as those related to the rolling element passing over a defect in the inner race or outer race of a bearing for example. In a similar way detected frequency components may be related to gear meshing frequencies. Such interpretations require an exact knowledge of the internal geometries of various machine components as well as a knowledge of the machine speed in order to allow calculation of the defect repetition frequencies. At slow machine speeds these defect repetition frequencies can be very low and are often not easy to detect amongst background signals from processes unrelated to machine condition. Interpretation typically requires one or more frequency windows to be set within the frequency spectrum and some measure of the amount of the signal within the frequency window to be alarmed upon when it exceeds a pre-determined value or alternatively trended as a function of time or operational cycles.

In both the vibration and AE fields it is additionally not unusual to relate the emergence or growth of activity at the higher frequencies of the detection bandwidth to the deterioration of the mechanical condition of some moving part of the machine. There is no known generally applicable interpretation of these frequency spectra which can be directly interpreted in terms of the condition of slowly rotating machinery. Typically a subjective decision is made as to which part of the spectrum to class as being high frequency and some measure of the amount of the signal within this frequency window is alarmed upon when it exceeds a pre-determined value or alternatively trended as a function of time or operational cycles.

In the time domain AE signals are typically processed either continuously or on a burst, event or hit basis. Continuous processing is most often carried out in terms of some measure of the signal level (such as rms value, rectified average or signal energy level) or in terms of AE counts where each count relates to the exceedance of an amplitude threshold level by the oscillatory AE signal. For continuous processing AE counts are counted either cumulatively or as a rate per unit time. Typically an increase in rms level etc. or AE count rate would be indicative of machinery degradation. One variant on these themes is to measure the time period over which the signal exceeds a threshold and is known as SAT (Signal Above Threshold). When these methods are applied in general it is usual for the interpretation to be made on the basis of the trend or the amount of increase from a starting value. There is no known generally applicable interpretation of these continuous signal processing methods to allow them to be directly interpreted in terms of the condition of slowly rotating machinery. Typically an alarm is triggered when the processed parameter exceeds a pre-determined value or alternatively the processed parameter is trended as a function of time or operational cycles

A brief period of increased AE signal magnitudes is known as a burst and is sometimes called an event or a hit. When AE signals are processed in terms of bursts it is usual to process the pulses from an AE counts processor and define the start of the burst as being when the first threshold crossing occurs and the end of the burst as when the last threshold crossing occurs within a certain waiting time (also known as a dead time). Bursts can be counted cumulatively or on a rate basis but in addition the activity within individual ones can be further processed in terms of many signal features such as rise-time, energy, peak amplitude, duration, number of AE counts etc. These characterisations of the burst activity may then be used in isolation or by statistical analysis (eg as a distribution) to infer perhaps subtle changes in the AE activity which are indicative of machinery degradation. There is no known generally applicable interpretation of these burst characterisations which can be directly interpreted in terms of the condition of slowly rotating machinery. Typically they are viewed as trend plots scatter plots (a graph showing one burst characterisation versus another) or as distribution plots (the number of bursts with a particular value of a particular burst characterisation versus the value of that burst characterisation).

It is noted that these previous methods require knowledge of previous measured values (ie past history) in order to be interpreted in terms of current machine condition.

### Object of the Invention

A basic object of the present invention is to provide a simple more direct method and apparatus for monitoring the condition or mechanical health of slowly rotating machinery by processing signals which are derived from the machinery in a way which reduces to a bare minimum the application specific knowledge required and removes the need for past history which are associated with the prior art methods and apparatus.

### Summary of a First Aspect of the Invention

According to a first aspect of the invention there is provided a method of monitoring the condition or mechanical health of slowly rotating machinery by processing signals from sensing means applied to the machinery, which processing approximately or exactly subdivides the period of a rotational cycle into a number of time or cyclic phase windows, each of which is long compared to the typical duration of a transient excitation of the structure at the frequency or frequencies of detection, applies a threshold level or acceptance criteria or calculates one in such a way that the presence or absence of any significant detectable activity in each of the time or phase windows can be determined for each rotational cycle and the fraction or percentage of those time or phase windows in which activity is present can be measured or averaged so as to provide a statistically significant indication of the extent of the activity throughout the rotational cycle.

### Advantages of the Invention

The signals may correspond to the acoustic emission, stress waves, noise, ultrasonics or vibration generated by an operating machine and detected by a transducer, microphone, accelerometer or other suitable sensor, sensing element or apparatus.

The threshold level or acceptance criteria may be derived from the continuous signal level which may be measured or calculated using any suitable circuitry and/or calculation to effect the measurement of rms value, peak average, rectified average, signal energy or other measure of the magnitude of the continuous signal level over a period of time comparable to or longer than the period of one revolution of the machine.

Through extensive field trials on machinery in industrial environments the resulting calculated fractional or percentage damage value has been shown to provide a widely applicable indicator of the presence and amount of damage within slowly rotating machinery. For the method to work it is only necessary for the period of rotation to be inputted, measured or calculated since all other system settings can be fixed even when the analysis is being carried out on signals from widely different machine types. For example with a suitably amplified signal form an AE sensor resonant at nominally 100 kHz and a threshold level automatically pre-set at 12 dB greater than the rectified average signal level over a period of one revolution of the machine and 100 time windows equally spaced over the period of one revolution it has been typically found that a fractional or percentage value of 5% or less corresponds to good condition and that increases beyond this value are indicative of spreading damage.

### Preferred or Optional Features

A number of time or cyclic phase windows is predetermined.

An amplified oscillatory signal from the transducer or sensor is compared to the threshold level and the presence of significant activity within a time window is recognised should the signal exceed the threshold at any time within the time window.

A dynamically enveloped signal level, fast rms level, signal energy level or signal peak level or other measure of the magnitude of the continuous signal level derived from the transducer or sensor, is compared to the threshold level and the presence of significant activity within a time window is recognised should the signal exceed the threshold at any time within the time window which approximates to a sub-division of the rotational period

A threshold level is calculated for comparison purposes which takes into account or is derived from the continuous sensor signal level and is measured or calculated using any suitable circuitry and/or calculation to effect the measurement of rms value, peak average, rectified average, signal energy or other measure of the magnitude of the continuous signal level.

The threshold level is self-adjusting to different machines and machine conditions by being automatically set to be a fixed increment or factor in excess of a value representative of the sensor signal level which itself is measured over a period comparable to, or longer than, the period of a rotational cycle.

The number of time window lies between 50 and 200.

The signals are derived from sensing means sensitive to acoustic emissions or stress waves generated by an operating machine.

The signals are derived from sensing means sensitive to airborne or structure borne ultrasonic activity generated by an operating machine.

The signals are derived from sensing means sensitive to airborne noise signals generated by an operating machine.

The signals are derived from sensing means sensitive to mechanical vibrations generated by an operating machine.

The machinery is rotating at a speed slower than 60 rpm.

### Summary of a Second Aspect of the Invention

According to a second aspect of the invention, there is provided apparatus for carrying out the method of the first aspect for monitoring the condition or health of slowly rotating machinery, comprising:

(i) sensing means adapted to be applied to the slowly rotating machinery and to emit signals in response to changes in the mechanical state or condition of the machinery; and

(ii) means to process signals derived from the sensing means, by which processing means the period of a rotational cycle is approximately or exactly sub-divided into a number of time or cyclic phase windows, each of which is long compared to the typical duration of a transient excitation of the structure at the frequency or frequencies of detection, a threshold level or acceptance criteria is applied or calculated in such a way that the presence or absence of any significant detectable activity in each of the time or phase windows can be determined for each rotational cycle and the fraction or percentage of those time or phase windows in which activity is present can be measured or averaged so as to provide a statistically significant indication of the extent of the activity throughout the rotational cycle.

### Preferred or Optional Features

The sensing means is/are sensitive to acoustic emissions or stress waves generated by an operating machine.

The sensing means is/are sensitive to airborne or structure borne ultrasonic activity generated by an operating machine.

The sensing means is/are sensitive to airborne noise signals generated by an operating machine.

The sensing means is/are sensitive to mechanical vibrations generated by an operating machine.

The sensing means comprises a transducer and a pre-amplifier.

The output of the pre-amplifier is to an amplifier.

The output of the amplifier is to an enveloping circuit having either a logarithmically or linearly sealed output.

The output of the circuit is to an analogue to digital converter.

The output of the converter is to a microprocessor.

The output of the microprocessor is to a display and/or storage medium and/or alarm and/or for combining with other data.

### BRIEF DESCRIPTION OF THE DRAWINGS

The present invention will be more fully described for the case of acoustic emissions detection by way of example with reference to the accompanying drawings in which:

FIG. 1 is a graph of “damage value” as ordinate against “days to failure” as abscissa; and

FIG. 2 is a diagrammatic arrangement apparatus for processing AE signals according to the present invention, showing the signal being processed as the envelope but the method could equally be applied to the amplified oscillatory AE signal without the need for an enveloping circuit.

### DETAILED DESCRIPTION OF THE DRAWINGS

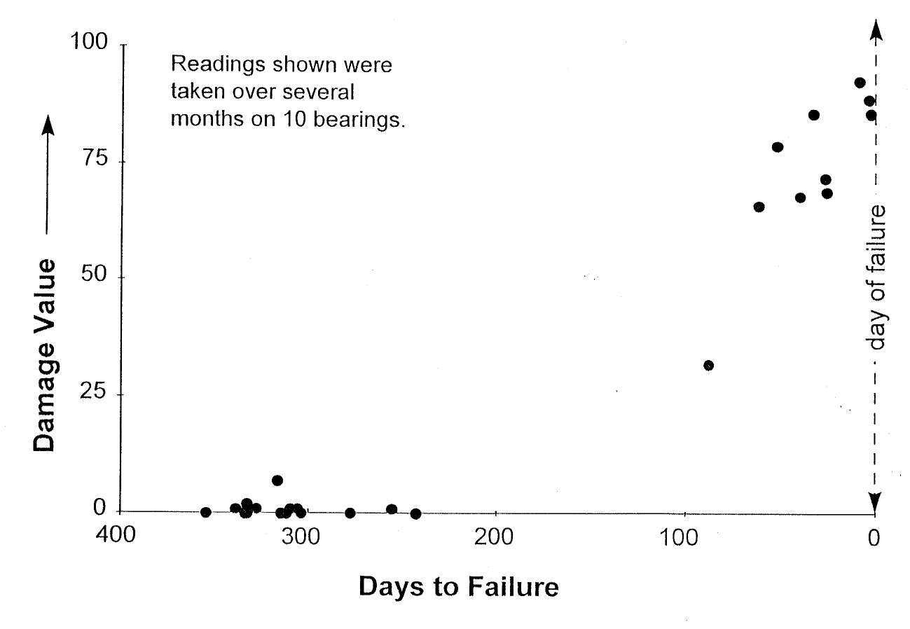

In FIG. 1, “damage value” is plotted as the ordinate, and “days to failure” is plotted as the abscissa.

For various measurements made on 10 turntable bearings in an industrial environment rotating at 6 rpm (ie 10 second period of revolution) with respect to the number of days until final failure. The graph shows clearly the increase in the damage value as failure approaches (in this application during the last 100 days of operation). A wide range of other machines including drying cylinders in paper mills, calender machines, rotating kilns, potato peeling machines, winding machines and extrusion machines also have been found to have a similar interpretation with damage values less than 5% indicating good condition. As a result of this wide and unconnected range of machines having a similar interpretation it is not unreasonable to extend this interpretation to all slowly rotating machinery with the exception of those machines where other background processes produce detectable signals.

Apparatus 1 for processing acoustic emissions to recognise features indicative of variations in the mechanical condition of slowly rotating machinery comprises a transducer 2 which is acoustically coupled to a machine which provides the source of Acoustic Emissions (also known as stress waves or sometimes structure borne ultrasonics). These Acoustic Emissions are commonly generated as a result of impacts and frictional processes within the machine due to mechanical distress or mechanical degradation. The transducer 2 is arranged to detect the Acoustic Emissions generated by or in the machine and produce an electrical signal dependent upon the Acoustic Emission activity detected. The transducer 2 is commonly a piezo-ceramic element although more than one transducer element may be simultaneously used or combined. Other suitable types of transducer include piezoelectric plastics, capacitative transducers, micromachined silicon sensor, electromagnetic transducers and laser interferometers.

The electrical signal produced by the transducer 2 is supplied to the preamplifier 3, which amplifies the electrical signal and may incorporate filtering to select the required frequencies of operation. The amplified electrical signal is then supplied to a further amplifier 4. The output of the amplifier 4 is supplied to a dynamic enveloping circuitry 5 which may have either a logarithmically or linearly scaled output. This signal is digitised by an analogue to digital converter 6 and further processed in a digital micro-electronic device such as a microprocessor 7.

The signal is processed in the microprocessor 7 according to a scheme consisting of three basic elements. The first basic element is the processing of the numerical values representative of the dynamically enveloped signal throughout a significant period of time compared with the period of one revolution (eg equal to the time taken for one full revolution) so as to allow a measure to be made which is indicative of the overall averaged signal magnitude, mean level value, rms value or other similar indicator of signal level and from this to compute a threshold level which is set to be higher than the aforesaid average, mean, rms or similar level, exceedance of which can be used to denote periods in which meaningful AE signal is present.

The second basic element is the acquisition of the period of one revolution which can either be manually supplied, measured from other sensory inputs or calculated from other known control or measurement parameters.

The third basic element is the sub-division of the period of one revolution into a number of time windows, each of which is long compared to the typical duration of a transient excitation of the structure at the frequency or frequencies of detection, within which the presence or absence of activity throughout the period of one or more revolutions will be noted and the fraction or percentage of these time windows within which AE activity is detected will be used as a parameter to be supplied to additional signal processing or fault recognition criteria, used as a parameter either in isolation or in conjunction with other related or unrelated parameters as an input to an alarm decision, stored in a memory device in order to allow subsequent analysis, displayed as a numeric, graphical or coloured indication of the magnitude of the current value or as a trend of historic values or used in a calculation to determine or indicate the immediacy of the need for improved lubrication, service attention or maintenance type action.

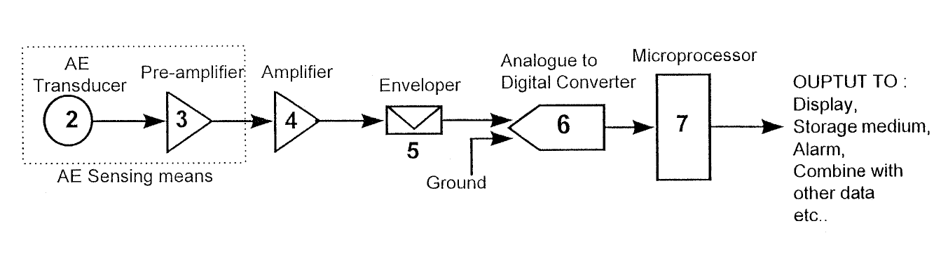

As an alternative to the analogue circuitry described in FIG. 2 the same methodology can in part be implemented by digital signal processing, and software residing in a microprocessor or other type of computer to achieve equivalent functionality.

As an alternative to the microprocessor based implementation the same methodology can be implemented in analogue and digital electronic circuitry to achieve equivalent functionality.

In addition to the common interpretation of the output from this detection and signal processing approach across different machine types and the ability to provide an immediate indication of health without the need for knowledge of internal design details or geometries, the approach described above also has the advantage that it does not require to be synchronised to the machines rotation in term of either the angular position of the rotating parts of the machine or a once per revolution signal from the machine. In fact the analysis does not require a precise measurement or stability of the machines rotational period and the calculated damage value according to the currently disclosed method and apparatus is relatively insensitive to variations in rotational speed such as may be experienced under different loading conditions or adjustments to process or production rates.

What I claim is

1. A method of monitoring the condition or mechanical health of slowly rotating machinery comprising processing signals from sensing means applied to the machinery, which processing approximately or exactly sub-divides the period of a rotational cycle into a number of time or cyclic phase windows, each of which is long compared to the typical duration of a transient excitation of the structure at the frequency or frequencies of detection, applies a threshold level or acceptance criteria or calculates one in such a way that the presence or absence of any significant detectable activity in each of the time or phase windows can be determined for each rotational cycle and the fraction or percentage of those time or phase windows in which activity is present can be measured or averaged so as to provide a statistically significant indication of the extent of the activity throughout the rotational cycle.

2. A method as claimed in claim 1, wherein a number of time or cyclic phase windows is predetermined.

3. A method as claimed in claim 1, wherein an amplified oscillatory signal from said sensing means is compared to said threshold level and the presence of significant activity within a time window is recognised should said signal exceed said threshold at any time within said time window.

4. A method as claimed in claim 1, wherein a dynamically enveloped signal level, fast rms level, signal energy level or signal peak level or other measure of the magnitude of a continuous signal level derived from said sensing means, is compared to said threshold level and the presence of significant activity within one of said time windows is recognised should said signal level exceed said threshold at any time within said time window which approximates to a sub-division of a rotational period.

5. A method as claimed in claim 1, wherein said threshold level is calculated for comparison purposes which takes into account, or is derived from, a continuous sensor signal level and is measured or calculated using any suitable circuitry and / or calculation to effect the measurement of rms value, peak average, rectified average, signal energy or other measure of the magnitude of said continuous signal level.

6. A method as claimed in claim 1, wherein said threshold level is self-adjusting to different machines and machine conditions to be monitored by being automatically set to be a fixed increment or factor in excess of a value representative of said sensor signal level which itself is measured over a period comparable to, or longer than, the period of a rotational cycle.

7. A method as claimed in claim 1, wherein the number of said time windows lies between 50 and 200.

8. A method as claimed in claim 1, wherein said signals are derived from a sensing means sensitive to acoustic emissions or stress waves generated by said slowly rotating machinery.

9. A method as claimed in claims 1, wherein said signals are derived from a sensing means sensitive to airborne or structure borne ultrasonic activity generated by said slowly rotating machinery.

10. A method as claimed in claims 1, wherein said signals are derived from a sensing means sensitive to airborne noise signals generated by said slowly rotating machinery.

11. A method as claimed in claims 1, wherein said signals are derived from a sensing means sensitive to mechanical vibrations generated by said slowly rotating machinery.

12. A method as claimed in claim 1, wherein said machinery is rotatable at a speed slower than 60 rpm.

13. Apparatus for monitoring the condition or health of slowly rotating machinery, comprising:
(i) sensing means adapted to be applied to said slowly rotating machinery and to emit signals in response to changes in the mechanical state or condition of said machinery; and
(ii) means to process signals derived from said sensing means, by which processing means the period of a rotational cycle is approximately or exactly sub-divided into a number of time or cyclic phase windows, each of which is long compared to the typical duration of a transient excitation of the structure at the frequency or frequencies of detection, a threshold level or acceptance criteria is applied or calculated in such a way that the presence or absence of any significant detectable activity in each of the time or phase windows can be determined for each rotational cycle and the fraction or percentage of those time or phase windows in which activity is present can be measured or averaged so as to provide a statistically significant indication of the extent of the activity throughout the rotational cycle.

14. Apparatus as claimed in claim 13, wherein said sensing means is/are sensitive to acoustic emissions or stress waves generated by said machinery.

15. Apparatus as claimed in claim 13, wherein said sensing means is/are sensitive to airborne or structure borne ultrasonic activity generated by said machinery.

16. Apparatus as claimed in claim 13, wherein said sensing means is/are sensitive to airborne noise signals generated by said machinery.

17. Apparatus as claimed in claim 13, wherein said sensing means is/are sensitive to mechanical vibrations generated by said machinery.

18. Apparatus as claimed in claim 13, wherein said sensing means comprises a transducer and a pre-amplifier.

19. Apparatus as claimed in claim 18, wherein an output of the pre-amplifier is fed to an amplifier.

20. Apparatus as claimed in claim 19, wherein an output of said amplifier is fed to an enveloping circuit having either a logarithmically or linearly sealed output.

21. Apparatus as claimed in claim 20, wherein an output of said circuit is to an analogue to digital converter.

22. Apparatus as claimed in claim 21, wherein an output of said converter is to a microprocessor.

23. Apparatus as claimed in claim 22, wherein an output of said microprocessor is to a display and/or storage medium and/or alarm and/or for combining with other data.
